(19) United States
(12) Patent Application Publication
(10) Pub. No.: US 2025/0279637 A1
(43) Pub. Date: Sep. 4, 2025

(54) REMOTE POWER SYSTEM RACK AND ASSEMBLY

(71) Applicant: SIGNIFY HOLDING B.V., EINDHOVEN (NL)

(72) Inventors: PRIYA RANJAN HARIDASAN, EAST SYRACUSE, NY (US); VLAD BURDUJA, ATLANTA, GA (US); WALTEN PETER OWENS, MANLIUS, NY (US); TYLER BRIAN MORRIS, LIVERPOOL, NY (US); ASHIMA SAXENA, PEACHTREE CITY, GA (US); BENJAMIN DAVID VOLLMER, MANLIUS, NY (US)

(21) Appl. No.: 18/863,720

(22) PCT Filed: May 15, 2023
(86) PCT No.: PCT/EP2023/062979

§ 371 Date: Nov. 7, 2024

Related U.S. Application Data
(60) Provisional application No. 63/345,277, filed on May 24, 2022.

(30) Foreign Application Priority Data
Jun. 7, 2022 (EP) 22177584.4

(51) Int. Cl. H02G 3/04; H02G 3/00

(52) U.S. Cl. CPC H02G 3/0456; H02G 3/0418; H02G 3/263

(57) ABSTRACT

A mounting rack for attachment of a remote power unit to a structure includes a first side frame, a second side frame, and a separator plate. The first side frame and the separator plate provide an alternating current (AC) wiring pathway therebetween for routing a first electrical cable. The second side frame and the separator plate provide a direct current (DC) wiring pathway therebetween for routing a second electrical cable. The AC wiring pathway and the DC wiring pathway are separated by the separator plate.

### TECHNICAL FIELD

The present disclosure relates generally to lighting, and more particularly to remote power system assemblies and ladder racks of the remote power system assemblies.

### BACKGROUND

Some outdoor lighting systems (e.g., sports lighting systems) may have support structures, such as poles and frames, that do not support lightheads (e.g., lighting emitting diode (LED) lightheads) that have integrated drivers. In such cases, remotely located power systems may be used to provide power to the lightheads. For example, a remote power system may be attached to a light pole (e.g., close to a base of the light pole) away from the lightheads that are located at a top end of the light pole. In some cases, attaching components of a remote power system to a pole may be challenging, particularly when alternating-current (AC) wires and direct-current (DC) wires should be separated from each other. Thus, a solution that provides for a proper installation of remote power systems and properly installed remote power systems may be desirable.

U.S. Pat. No. 6,215,069B1 relates to a modular cable management panel assembly includes a panel, a set of rings mounted on a surface of the panel and a cover coupled to the rings. The rings are spaced along the panel longitudinal axis and have openings extending laterally through them. The cover is movable between a closed position extending over and closing the ring openings and an open position spaced from the ring openings to allow cables to pass laterally into and out of the rings. The panel assembly is adaptable for mounting various accessories.

EP0844713A1 relates to a cable duct made from at least two U-section side modules with grilles to form a Faraday cage, a base and a cover made from a composition material with electromagnetic shielding, cross bars for supporting the cables, and systems for ensuring radio-electrical continuity between the base and cover and between the modules of the duct and the premises in which it is installed. The grille is made from perforated brass with a weight of about 1 kg/sq m, while the radio-electrical continuity between modules is provided by high-frequency joints of copper/nickel. The composition material used for the base and cover is of fiberglass fabric and fire-resistant polyester resin. The assembled duct, apart from the seals is covered with a phenol resin.

WO2014068382A2 relates to a tamper-resistant cable cover assembly suitable for covering cables that are carried by a cable rack or cable ladder so as to protect such cables against unauthorized tampering or vandalism. The cable cover assembly comprises a cable cover plate which is adapted to engage the cable rack, tray or ladder so as at least partially to sandwich the cables between the cable cover plate and the cable rack, tray or ladder; and connecting means for connecting the cable cover plate to the cable rack, tray or ladder. The cable cover assembly also may include a backing plate which is adapted to engage the cable rack, tray or ladder, the arrangement being such that the cable cover plate engages the cable rack, tray or ladder from one side thereof, while the backing plate engages the cable rack, tray or ladder from an opposite side thereof, so as at least partially to sandwich the cable rack, tray or ladder between the cable cover plate and the backing plate.

### SUMMARY

The present disclosure relates generally to lighting, and more particularly to remote power system assemblies and ladder racks of the remote power system assemblies. In an example embodiment, a mounting rack for attachment of a remote power unit to a structure includes a first side frame, a second side frame, and a separator plate. The first side frame and the separator plate provide an alternating current (AC) wiring pathway therebetween for routing a first electrical cable. The second side frame and the separator plate provide a direct current (DC) wiring pathway therebetween for routing a second electrical cable. The AC wiring pathway and the DC wiring pathway are separated by the separator plate. Further including a bottom plate attached to the first side frame and the second side frame, the bottom plate having a first wire opening aligned with the AC wiring pathway and a second wire opening aligned with the DC wiring pathway, and a top plate attached to the first side frame and the second side frame, the top plate having a third wire opening aligned with the AC wiring pathway and a fourth wire opening aligned with the DC wiring pathway.

In another example embodiment, a remote power unit assembly includes a remote power unit and a bracket attached to the remote power unit. The remote power unit assembly further includes a mounting rack that includes a first side frame, a second side frame (404), and a separator plate. The first side frame and the separator plate provide an AC wiring pathway therebetween for routing a first electrical cable. The second side frame and the separator plate provide a DC wiring pathway therebetween for routing a second electrical cable. The AC wiring pathway and the DC wiring pathway are separated by the separator plate. The bracket is attached to the first side frame and the second side frame. The first side frame and the second side frame each comprise a fastener hole, and wherein the bracket is attached to the first side frame and the second side frame using one or more fasteners extending through the fastener hole of each of the first side frame and the second side frame, and the mounting rack further comprises a hollow tube aligned with the fastener hole of each of the first side frame and the second side frame and wherein the hollow tube extends through a hole in the separator plate.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates an outdoor lighting system according to an example embodiment;

FIG. 2 illustrates a remote power system of the outdoor lighting system of FIG. 1 according to an example embodiment;

FIGS. 3A and 3B illustrate a remote power unit for use in the remote power system of FIG. 2 according to an example embodiment;

FIGS. 4A-4D illustrate different views of a mounting rack for use in the remote power system of FIG. 2 for attaching the remote power unit of FIG. 3 to a pole according to an example embodiment;

FIGS. 5A and 5B illustrate the mounting rack of FIGS. 4A-4D with some components omitted for clarity of illustration according to an example embodiment;

FIG. 6 illustrates the mounting rack of FIGS. 4A-4D with attached mounting bands according to an example embodiment;

FIGS. 7A-7C illustrate different views of a remote power unit assembly including the remote power unit of FIGS. 3A and 3B and the mounting rack of FIGS. 4A-4D according to an example embodiment;

FIGS. 8A-8D illustrate different views of a power connection box of the remote power system of FIG. 2 according to an example embodiment;

FIG. 9 illustrates a remote power system of an outdoor lighting system according to another example embodiment;

FIG. 10 illustrates a remote power unit assembly for use in the remote power system of FIG. 9 according to an example embodiment;

FIGS. 11A-11C illustrate different views of a mounting rack of the remote power unit assembly of FIG. 10 used for attaching the remote power unit assembly of FIG. 10 to a pole according to an example embodiment;

FIGS. 12A and 12B illustrate the mounting rack of FIGS. 11A-4C with side panels removed for clarity of illustration according to an example embodiment; and

FIGS. 13A and 13B illustrate different views of a power connection box of the remote power system of FIG. 9 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

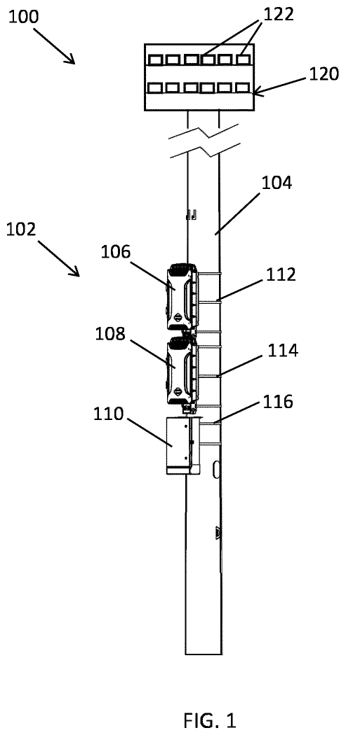

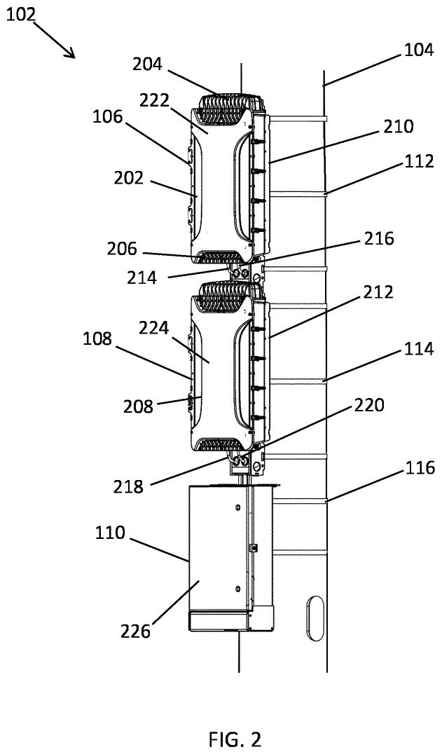

FIG. 1 illustrates an outdoor lighting system 100 according to an example embodiment, and FIG. 2 illustrates a remote power system 102 of the outdoor lighting system 100 of FIG. 1 according to an example embodiment. In some example embodiments, the outdoor lighting system 100 includes a lighthead assembly 120 and the remote power system 102. The lighthead assembly 120 may be attached to a pole 104 at a top end portion of the pole 104. The remote power system 102 may be attached to the pole 104 or to another structure (e.g., a wall) at a location distal from the lighthead assembly 120. The remote power system 102 may receive AC power, for example, via an electrical cable (e.g., one or more electrical wires) that is routed up through the pole 104 from below the remote power system 102. The remote power system 102 may generate DC power from the AC power and provide the DC power to the lightheads, such as lightheads 122, of the lighthead assembly 120. For example, the remote power system 102 may provide the DC power to the lightheads of the lighthead assembly 120 via one or more electrical cables connected to the power connection box and routed inside the pole 104. The lightheads of the lighthead assembly 120 may be LED lightheads.

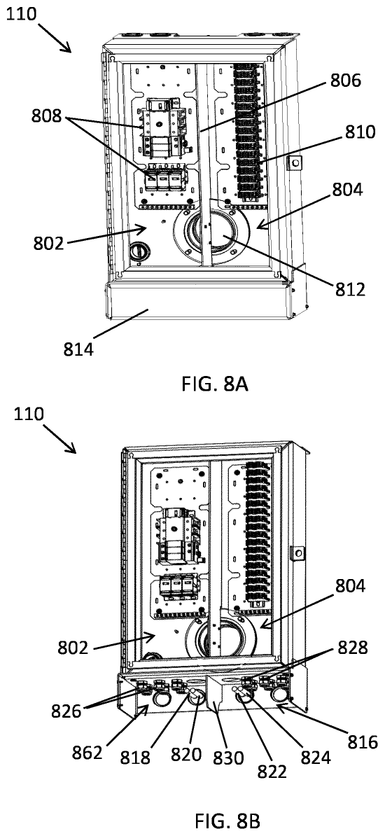

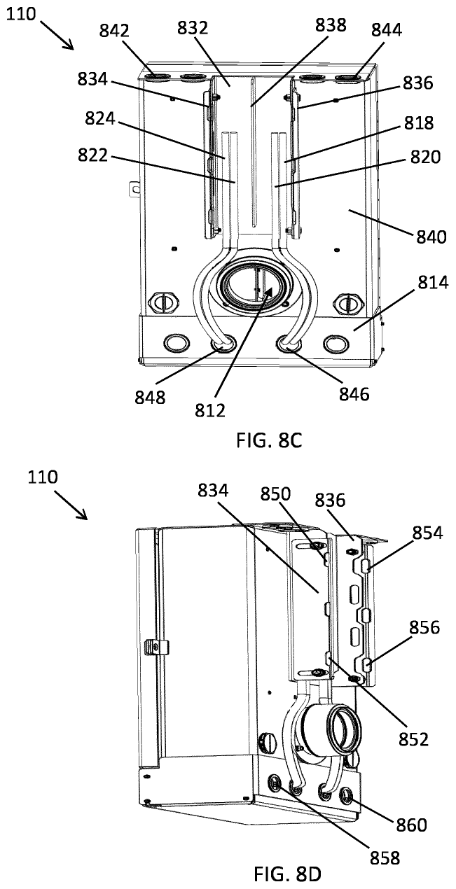

In some example embodiments, the remote power system 102 may include remote power units 106, 108 and a power connection box 110. The remote power unit 106 is attached to a mounting rack 210, and the remote power unit 108 is attached to a mounting rack 212 (as more clearly shown in FIG. 2). An assembly of the remote power unit 106 and the mounting rack 210 may be attached to the pole 104 by one or more bands (e.g., the band 112) that extend around pole 104. In particular, the remote power unit 106 may be attached to the mounting rack 210 that is attached to the pole 104 by one or more bands. Alternatively or in addition, other attachment structures may be used to attach the mounting rack 210 to the pole 104. An assembly of the remote power unit 108 and the mounting rack 212 may be attached to the pole 104 by one or more bands (e.g., the band 114) that extend around the pole 104. In particular, the remote power unit 108 may be attached to the mounting rack 212 that is attached to the pole 104 by one or more bands. Alternatively or in addition, other attachment structures may be used to attach the mounting rack 210 to the pole 104. The power connection box 110 may be attached to a bracket (more clearly shown in FIG. 8C) that is attached to the pole 104 by one or more bands (e.g., the band 116). Alternatively or in addition, other attachment structures may be used to attach the power connection box 110 to the pole 104.

In some example embodiments, the remote power unit 106 may include a housing 202 and heat sink structures 204, 206. The heat sink structures 204, 206 may be separate structures from the housing 202 or may be integral portions of the housing 202. The housing 202 may be designed to protect components inside the housing 202 from water exposure. For example, the remote power unit 106 may include one or more drivers (e.g., LED drivers) that receive AC power and generate DC power that is provided to some lightheads of the lighthead assembly 120. The driver(s) of the remote power unit 106 may be accessed by opening a door 222 of the housing 202.

In some example embodiments, the remote power unit 108 may include a housing 208 and heat sink structures similar to those of the remote power unit 106. The housing 208 may be designed to protect components inside the housing 208 from water exposure. For example, the remote power unit 108 may include one or more drivers (e.g., LED drivers) that receive AC power and generate DC power that is provided to some lightheads of the lighthead assembly 120. The driver(s) of the remote power unit 108 may be accessed by opening a door 224 of the housing 208.

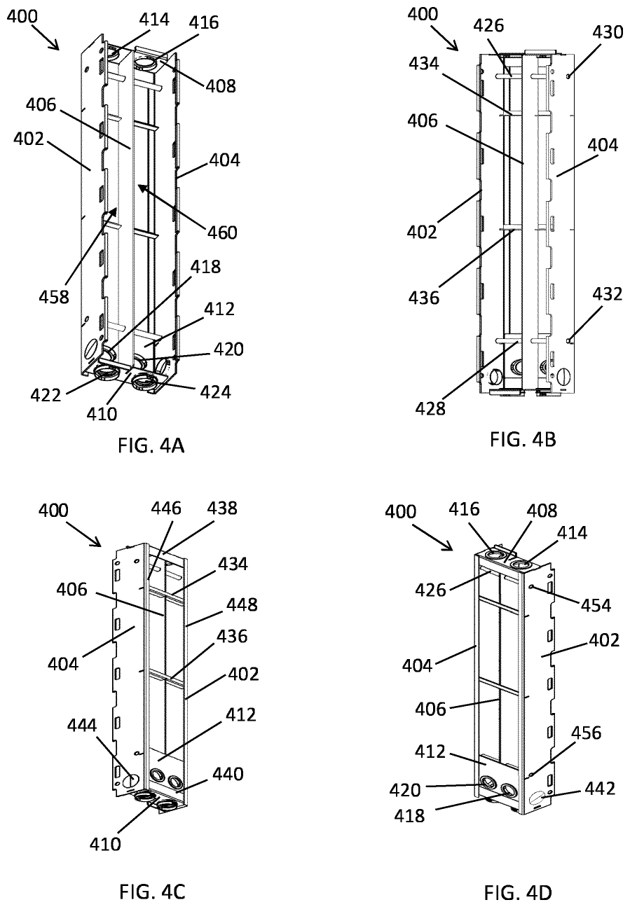

In some example embodiments, electrical cables 214, 216 may extend from the remote power unit 106 to the power connection box 110. For example, the electrical cable 214 may be used for AC power connection between the power connection box 110 and the remote power unit 106, and electrical cable 216 may be used for DC power connection between the remote power unit 106 and the power connection box 110. To illustrate, AC power (e.g., from power utility) may be provided to the remote power unit 106 over the electrical cable 214 via the power connection box 110. The remote power unit 106 may generate DC power from the AC power and may provide the DC power to some lightheads of the lighthead assembly 120 over the electrical cable 216 via the power connection box 110 and one or more electrical cables connected to the power connection box 110 and routed to the lighthead assembly 120 through the inside of the pole 104. The electrical cables 214, 216 may be routed to the power connection box 110 through wiring pathways provided by the mounting racks 210, 212. The electrical cables 214, 216 may be routed separated from each other by separator plates of the mounting racks 210, 212 in a manner described below with respect to a mounting rack 400 of FIGS. 4A-4D.

In some example embodiments, electrical cables 218, 220 may extend from the remote power unit 108 to the power connection box 110. For example, the electrical cable 218 may be used for AC power connection between the power connection box 110 and the remote power unit 108, and electrical cable 220 may be used for DC power connection between the remote power unit 108 and the power connection box 110. To illustrate, AC power (e.g., from power utility) may be provided to the remote power unit 108 over the electrical cable 218 via the power connection box 110. The remote power unit 108 may generate DC power from the AC power and may provide the DC power to some lightheads of the lighthead assembly 120 over the electrical cable 220 via the power connection box 110 and one or more electrical cables connected to the power connection box 110 and routed to the lighthead assembly 120 through the inside of the pole 104. The electrical cables 218, 220 may be routed to the power connection box 110 through wiring pathways provided by the mounting rack 212. The electrical cables 218, 220 may be routed separated from each other by a separator plate of the mounting rack 212 in a manner described below with respect to a mounting rack 400 of FIGS. 4A-4D.

In some example embodiments, the electrical cables 214, 218 may be routed behind and/or inside the power connection box 110 separated from the electrical cables 216, 220 to provide separation of AC and DC power wirings. The power connection box 110 may include separate compartments for AC and DC power connections as explained in more detail below with respect to FIGS. 8A-8D. The compartments of the power connection box 110 may be accessed by opening a door 226 of the power connection box 110.

Because the remote power system 102 provides DC power to the lighthead assembly 120 while remotely located from the lighthead assembly 120, the lightheads of the lighthead assembly 120 do not need to include local power supplies. By eliminating the need for the lightheads to incorporate a driver, the remote power system 102 enables replacement of non-LED lightheads with LED lightheads. By providing separate wiring pathways and compartments for AC and DC power connections, the remote power system 102 improves the separation of AC and DC power, which can, for example, reduce signal interference. The separation of the remote power units 106, 108 from each other by at least the portion of the mounting rack 210 that is below the remote power unit 106 may provide adequate spacing for efficient dissipation of heat from the remote power units 106, 108.

Although two remote power units are shown in FIGS. 1 and 2, in some alternative embodiments, the remote power system 102 may include more or fewer remote power units without departing from the scope of this disclosure. In some alternative embodiments, one or more of the remote power units 106, 108 and the power connection box 110 may be attached to the pole 104 at different locations than shown without departing from the scope of this disclosure. In some example embodiments, electrical cables described above with respect to AC power may be used for DC power connection while the electrical cables described above with respect to DC power may be used for AC power connection without departing from the scope of this disclosure.

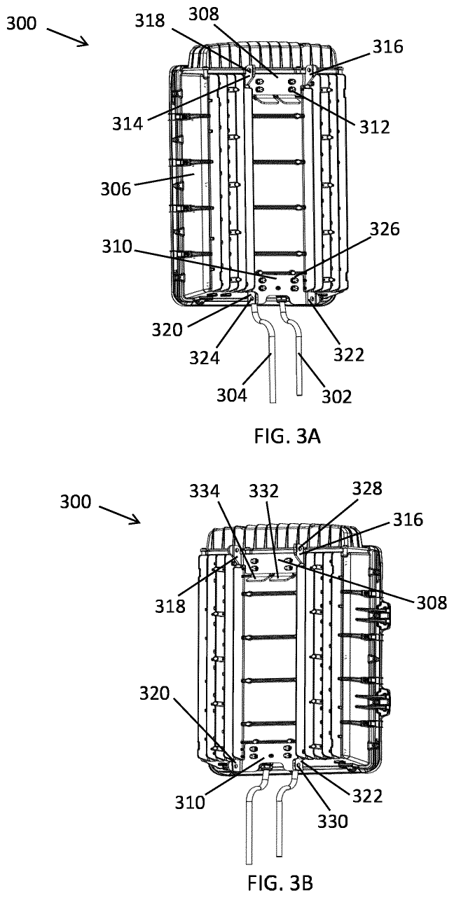

FIGS. 3A and 3B illustrate a remote power unit 300 for use in the remote power system 102 of FIG. 2 according to an example embodiment. For example, the remote power unit 300 may correspond to each one of the remote power units 106 and 108. In some example embodiments, the remote power unit 300 may include a housing 306 that holds, for example, one or more drivers (not shown), such as LED drivers. Electrical cables 302, 304 may be electrically connected to (i.e., in electrical connection with) the drivers inside the housing 306 or via connectors attached to the housing 306. To illustrate, the electrical cable 302 may be used for AC power connection, and the electrical cable 304 may be used for DC power connection. For example, the electrical cables 302 and 304 may correspond, respectively, to the electrical cables 214 and 216 and, respectively to the electrical cables 218, 220 shown more clearly in FIG. 2.

In some example embodiments, brackets 308, 310 may be attached to the housing 306 of the remote power unit 300. The bracket 308 may be used to attach the remote power unit 300 to a mounting rack, such as the mounting racks 210, 212 shown in FIG. 2. The brackets 308 may be attached to the housing 306 on a back side of the remote power unit 300 using one or more fasteners (e.g., screws), such as the fastener 312. The bracket 308 may include attachment tabs 314, 316 that extend away from the housing 306. The tab 314 may include an attachment hole 318 for extending a fastener therethrough, and the tab 316 may include an attachment hole 328 for extending the same or another fastener therethrough. The bracket 308 may also include retention tabs 332, 334 that extend angularly away from the housing 306 and designed to be positioned on a horizontal structure (e.g., a support rung) of a mounting rack to help retain the remote power unit 300 attached to the mounting rack.

In some example embodiments, the bracket 310 may be attached to the housing 306 on the back side of the remote power unit 300 using one or more fasteners (e.g., screws), such as the fastener 326. The bracket 310 may include tabs 320, 322 that extend away from the housing 306. The tab 320 may include an attachment hole 324 for extending a fastener therethrough for attaching the remote power unit 300 to a mounting rack (e.g., the mounting rack 210 of FIG. 2), and the tab 322 may include an attachment hole 330 for extending the same or another fastener therethrough.

In some alternative embodiments, the remote power unit 300 may have a different shape than shown without departing from the scope of this disclosure. In some alternative embodiments, the brackets 308, 310 may have different shapes and/or may be attached at different locations than shown without departing from the scope of this disclosure. In some alternative embodiments, the bracket 310 may include retention tabs similar to the retention tabs 332, 334 of the bracket 308 without departing from the scope of this disclosure. In some alternative embodiments, one or more of the retention tabs 332, 334 of the bracket 308 may be omitted without departing from the scope of this disclosure. In some alternative embodiments, the brackets 308, 310 may be attached to the housing 306 of the remote power unit 300 using other means than shown without departing from the scope of this disclosure. In some alternative embodiments, one or more brackets in addition to the brackets 308, 310 may be attached to the housing 306 without departing from the scope of this disclosure. In some alternative embodiments, one of the brackets 308, 310 may be omitted without departing from the scope of this disclosure.

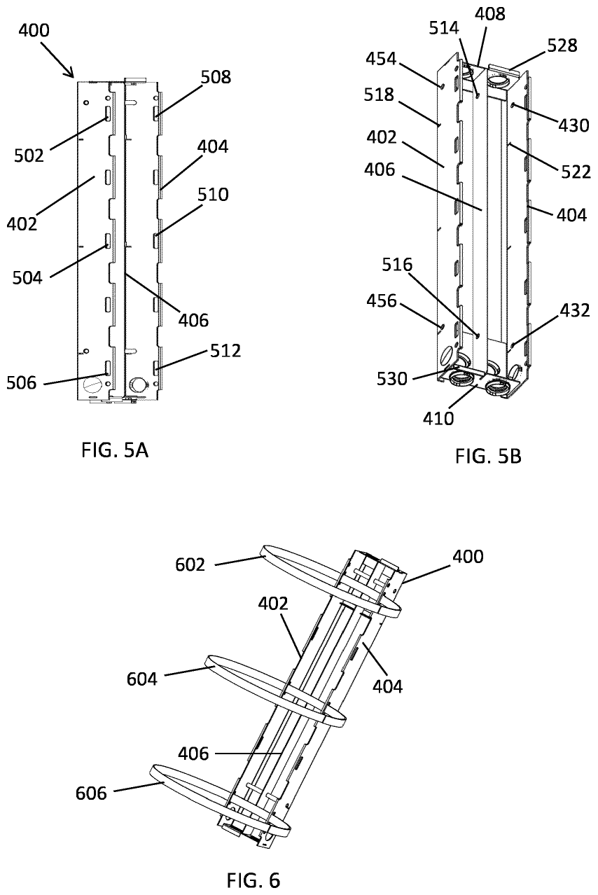

FIGS. 4A-4D illustrate different views of a mounting rack 400 for use in the remote power system 102 of FIG. 2 for attaching the remote power unit 300 of FIG. 3 to the pole 104 of FIG. 1 according to an example embodiment, and FIGS. 5A and 5B illustrate the mounting rack 400 of FIGS. 4A-4D with some components omitted for clarity of illustration according to an example embodiment. In some example embodiments, the mounting rack 400 includes side frame 402, 404, and a separator plate 406 that extends longitudinally along with and between the side frames 402, 404. The side frame 402 and the separator plate 406 may provide a wiring pathway 458 for routing one or more electrical cables, and the side frame 404 and the separator plate 406 may provide another wiring pathway 460 for routing another one or more electrical cables. For example, the wiring pathway 458 may be used for routing one or more electrical cables that are used for AC power connection, and the wiring pathway 460 may be used for routing one or more electrical cables that are used for DC power connection. The separator plate 406 is positioned to separate one or more electrical cables that are routed in the wiring pathway 458 from one or more electrical cables that are routed in the wiring pathway 460.

In some example embodiments, the mounting rack 400 may include a top plate 408, a bottom plate 410, and a front plate 412 proximal to the bottom plate 410. The top plate 408 may include wire openings 414, 416. For example, the wire opening 414 may be aligned with the wiring pathway 458, and the wire opening 416 may be aligned with the wiring pathway 460. The front plate 412 may include wire openings 418, 420. For example, the wire opening 418 may be aligned with the wiring pathway 458, and the wire opening 420 may be aligned with the wiring pathway 460. The bottom plate 410 may include wire openings 422, 424. For example, the wire opening 422 may be aligned with the wiring pathway 458, and the wire opening 424 may be aligned with the wiring pathway 460.

In some example embodiments, the mounting rack 400 may include support rungs 434, 436 that extend between the side frame 402 and the side frame 404. The support rungs 434, 436 may provide structural support to the mounting rack 400. For example, the support rung 434 may be attached to the side frame 402, where an end portion (e.g., an end tab) of the support rung 434 is inserted in a slot 518 shown in FIG. 5B. The support rung 434 may be also attached to the side frame 404, where another end portion (e.g., an end tab) of the support rung 434 is inserted in a slot 522 shown in FIG. 5B. In some alternative embodiments, the support rung 434 may be attached to the side frames 402, 404 in a different manner (e.g., fasteners and/or welding) without departing from the scope of this disclosure. The support rung 436 may be attached to the side frames 402, 404 in the manner described with respect to the support rung 434.

In some example embodiments, the mounting rack 400 includes hollow tubes 426, 428 that are designed to receive fasteners that are used to attach the remote power unit 300 to the mounting rack 400. The hollow tubes 426, 428 may be fully or partially hollow. The hollow tubes 426, 424 may also be threaded to receive a threaded fastener. The hollow tube 426 may be aligned with a fastener hole 454 in the side frame 402 (as more clearly shown in FIG. 4D) such that a fastener can extend through the fastener hole 454 and the hollow tube 426. The hollow tube 426 may also be aligned with a fastener hole 430 in the side frame 404 (as more clearly shown in FIG. 4B) such that the same fastener or another fastener can extend through the fastener hole 430 and the hollow tube 426. The hollow tube 430 may also extend through a hole 514 (shown in FIG. 5B) of the separator plate 406, which may restrict the movement of the separator plate 406 while retaining the hollow tube 426 in position.

In some example embodiments, the hollow tube 428 may be aligned with a fastener hole 456 in the side frame 402 (as more clearly shown in FIG. 4D) such that a fastener can extend through the fastener hole 456 and the hollow tube 428. The hollow tube 428 may also be aligned with a fastener hole 432 in the side frame 404 (as more clearly shown in FIG. 4B) such that the same fastener or another fastener can extend through the fastener hole 432 and the hollow tube 428. The hollow tube 432 may also extend through a hole 516 (shown in FIG. 5B) of the separator plate 406, which may restrict the movement of the separator plate 406 while retaining the hollow tube 428 in position.

In some example embodiments, the top plate 408 may include a downward flange 438, and the bottom plate 410 may include an upward flange 440. The side frame 402 may include a flange 446, and the side frame 404 may include a flange 448. For example, the flanges 438, 440, may help retain the separator plate 406 in place, and the flanges 446, 448 may help retain the support rungs 434, 436 in place.

In some example embodiments, the side frame 402 may include a knockout piece 442, and the side frame 404 may include a knockout piece 444. For example, the knockout piece 442 may be removed to provide an additional wire opening to the wiring pathway 458, and the knockout piece 444 may be removed to provide an additional wire opening to the wiring pathway 460.

In some example embodiments, one or more electrical cables may extend through the wire opening 414, the wiring pathway 458, and the wire opening 422, and one or more electrical cable may extend through the wire opening 416, the wiring pathway 460, and the wire opening 424. For example, considering the mounting rack 400 as corresponding to the mounting rack 212 of FIG. 2, the electrical cable 214 may be routed be through the wire opening 414, the wiring pathway 458, and the wire opening 422, and the electrical cable 216 may be routed be through the wire opening 416, the wiring pathway 460, and the wire opening 424 separated from the electrical cable 214 by the separator plate 406.

In some example embodiments, the one or more electrical cables may extend through the wire opening 418, the wiring pathway 458, and the wire opening 422, and one or more electrical cable may extend through the wire opening 420, the wiring pathway 460, and the wire opening 424. For example, considering the mounting rack 400 as corresponding to the mounting rack 210 of FIG. 2, the electrical cable 214 (shown in FIG. 2) may be routed be through the wire opening 418, the wiring pathway 458, and the wire opening 422, and the electrical cable 216 (shown in FIG. 2) may be routed be through the wire opening 420, the wiring pathway 460, and the wire opening 424 separated from the electrical cable 214 by the separator plate 406. As another example, considering the mounting rack 400 as corresponding to the mounting rack 212 of FIG. 2, the electrical cable 218 (shown in FIG. 2) may be routed be through the wire opening 418, the wiring pathway 458, and the wire opening 422, and the electrical cable 220 (shown in FIG. 2) may be routed be through the wire opening 420, the wiring pathway 460, and the wire opening 424 separated from the electrical cable 218 by the separator plate 406.

Referring to FIGS. 5A and 5B, in some example embodiments, the top plate 408 may include a tab 528, and the bottom plate 410 may include a tab 530. The tabs 528, 530 may be used in the alignment of the mounting rack 400 with another one of the mounting rack 400. For example, considering the mounting racks 210 and 212 of FIG. 2 as corresponding to the mounting rack 400, the tab 528 of the top plate 408 of the mounting rack 212 and the tab 530 of the bottom plate 410 of the mounting rack 210 may help align the mounting rack 210 with the mounting rack 212.

In some example embodiments, the side frame 402 may include slots 502, 504, 506, and the side frame 404 may include slots 508, 510, 512. For example, the slots 502 and 508 may be aligned with each other, the slots 504 and 510 may be aligned with each other, and the slots 512 and 514 may be aligned with each other. The slots 502-512 may be used for attaching the mounting rack 400 to the pole 104 of FIGS. 1 and 2 using mounting bands.

To illustrate, FIG. 6 illustrates the mounting rack 400 with attached mounting bands 602, 604, 606 according to an example embodiment. Referring to FIGS. 5A-6, in some example embodiments, the mounting band 602 may be inserted through the slot 502 of the side frame 402 and through the slot 508 of the side frame 404. The mounting band 604 may be inserted through the slot 504 of the side frame 402 and through the slot 510 of the side frame 404. The mounting band 606 may be inserted through the slot 506 of the side frame 402 and through the slot 512 of the side frame 404. The mounting bands 602-606 may be used to attach the mounting rack 400 to the pole 104 shown in FIGS. 1 and 2.

In some example embodiments, the mounting rack 400 may be made from sheet metal, such as aluminum and/or steel sheet metal, using methods such as cutting, bending, welding, etc. The mounting bands 602-606 may also be made from aluminum and/or steel sheet metal using methods such as cutting, bending, welding, etc.

Referring to FIGS. 4A-6, in some alternative embodiments, the hollow tubes 426, 436 and the support rungs 434, 436 may be at different locations than shown without departing from the scope of this disclosure. In some alternative embodiments, the mounting rack 400 may include more or fewer hollow tubes and support rungs than shown without departing from the scope of this disclosure. In some alternative embodiments, the separator plate 406 may be at a different location relative to the side frames 402, 404 without departing from the scope of this disclosure. In some alternative embodiments, the side frames 402, 404 of the mounting rack 400 may include more or fewer of the slots 502-512 than shown without departing from the scope of this disclosure. In some alternative embodiments, one or more elements (e.g., the side frame 402, the side frame 404, etc.) may have a different shape than shown without departing from the scope of this disclosure. In some alternative embodiments, the mounting rack 400 may include more or fewer wire holes than shown without departing from the scope of this disclosure. In some alternative embodiments, some of the elements of the mounting rack 400 may be attached in a different manner than shown without departing from the scope of this disclosure.

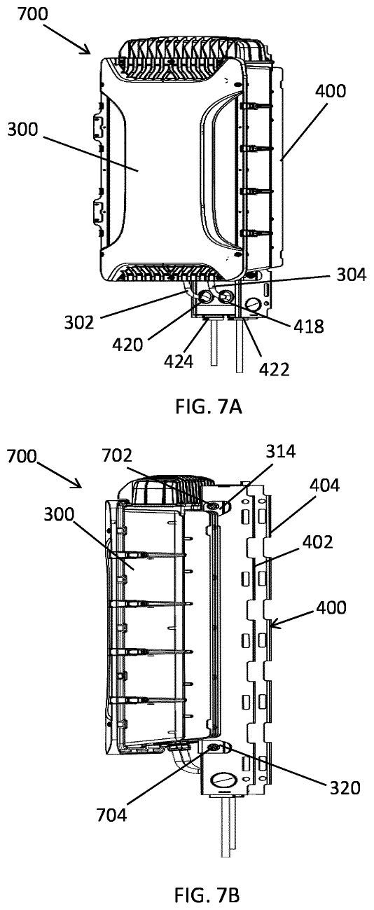

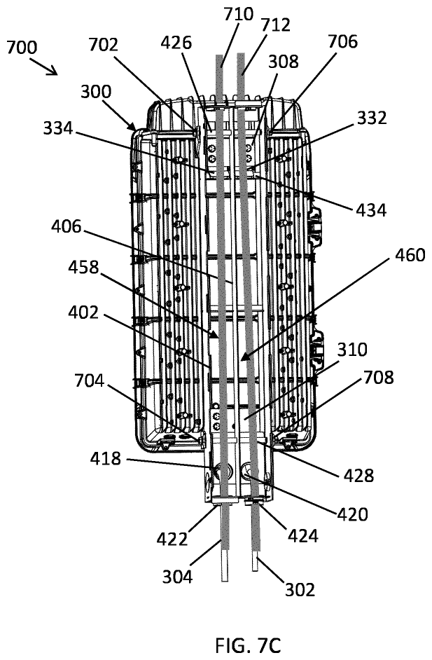

FIGS. 7A-7C illustrate different views of a remote power unit assembly 700 including the remote power unit 300 of FIGS. 3A and 3B and the mounting rack 400 of FIGS. 4A-4D according to an example embodiment. Referring to FIGS. 3A-7C, in some example embodiments, the electrical cable 304 may be routed through the wire opening 418 of the front plate 412, the wiring pathway 458, and the wire opening 422 of the bottom plate 410 of the mounting rack 400. The electrical cable 302 may be routed through the wire opening 420 of the front plate 412, the wiring pathway 460, and the wire opening 424 of the bottom plate 410 of the mounting rack 400.

In some example embodiments, electrical cable 710 may extend through the wire opening 414, the wiring pathway 458, and the wire opening 422, and electrical cable 712 may extend through the wire opening 416, the wiring pathway 460, and the wire opening 424. The electrical cables 710 and 712 (shown more clearly in FIG. 7C) are routed through the wiring pathways 458 and 460, respectively, separated from each other by the separator plate 406. Considering the mounting rack 212 of FIG. 2 as corresponding to the mounting rack 400, the electrical cable 710 may correspond to the electrical cable 216, and the electrical cable 712 may correspond to the electrical cable 214.

In some example embodiments, a fastener 702 may extend through the hollow tube 426 attaching the bracket 308 to the mounting rack 400, thereby attaching the remote power unit 300 to the mounting rack 400 as more clearly shown in FIGS. 7B and 7C. For example, the fastener 702 (e.g., a screw) may extend through the fastener hole 430 in the side frame 402, the fastener hole 454 in the side frame 404, and the hollow tube 426, where the fastener 702 is secured by a nut 706. The retention tabs 332, 334 of the bracket 308 may be positioned on the support rung 434 of the mounting rack 400 to help retain the remote power unit 300 attached to the mounting rack 400.

In some example embodiments, a fastener 704 may extend through the hollow tube 428 attaching the bracket 310 to the mounting rack 400, thereby attaching the remote power unit 300 to the mounting rack 400 as more clearly shown in FIGS. 7B and 7C. The fastener 704 (e.g., a screw) may extend through the fastener hole 432 in the side frame 402, the fastener hole 456 in the side frame 404, and the hollow tube 428, where the fastener 704 is secured by a nut 708.

In some alternative embodiments, the electrical cables 710, 712 may be omitted without departing from the scope of this disclosure. In some alternative embodiments, the brackets 308, 310 may be attached to the mounting rack 400 using means other than the fasteners 702, 704 without departing from the scope of this disclosure.

FIGS. 8A-8D illustrate different views of the power connection box 110 of the remote power system 102 of FIG. 2 according to an example embodiment. In some example embodiments, the power connection box 110 may have an AC compartment 802 and a DC compartment 804. The AC compartment 802 and the DC compartment 804 may be separated from each other by a separator wall 806. The AC compartment 802 may contain components 808 such as surge protector, circuit breakers, etc. The DC compartment 802 may include components 810 such as wire connectors, etc. The power connection box 110 may be made from sheet metal, such as aluminum and/or steel sheet metal, using methods such as cutting, bending, welding, etc.

In some example embodiments, the power connection box 110 may include a wire opening 812 for routing electrical cables. For example, the power connection box 110 may be mounted to the pole 104 of FIGS. 1 and 2 such that the wire opening 812 is aligned with an opening in the pole 104 for routing electrical cables between the power connection box 110 and the inside of the pole 104. The separator wall 806 may enable the routing of AC power cables and DC power cables spaced from each other through the wire opening 812.

In some example embodiments, the power connection box 110 includes a wiring compartment 814 that has an AC wiring section 862 and a DC wiring section 816 that are separated from each other by a separator structure 830 (e.g., a plate). The wiring compartment 814 is shown in FIG. 8B with the cover removed for clarity of illustration. For example, electrical cables 818, 820, which may be used for AC power connection between the power connection box 110 and the remote power unit 300 shown in FIGS. 7A-7C, may be routed into the AC wiring section 862 through a wire opening 846. For example, in FIGS. 8A-8D, the electrical cables 818, 820 may each be a segment of or otherwise connected to a respective one of the electrical cables 304, 710 (shown in FIG. 7C). The electrical cables 818, 820 may be routed between the AC wiring section 862 and the AC compartment 802 of the power connection box 110 through a respective one of the wire grips 826.

In some example embodiments, electrical cables 822, 824, which may be used for DC power connection between the power connection box 110 and the remote power unit 300 shown in FIGS. 7A-7C, may be routed into the DC wiring section 816 through a wire opening 848. For example, in FIGS. 8A-8D, the electrical cables 822, 824 may each be a segment of or otherwise connected to a respective one of the electrical cables 302, 712 (shown in FIG. 7C). The electrical cables 822, 824 may be routed between the DC wiring section 816 and the DC compartment 804 of the power connection box 110 through a respective one of the wire grips 828.

In some example embodiments, the electrical cables 818, 820 may be routed separated from the electrical cables 822, 824 on a back side of the power connection box 110 as more clearly shown in FIG. 8C. To illustrate, a mounting bracket 832 that includes sidewalls 834, 836 and separator wall 838 may be attached to a backwall 840 of the power connection box 110, where the electrical cables 818, 820 may be routed between the sidewall 836 and the separator wall 838 and where the electrical cables 822, 824 may be routed between the sidewall 834 and the separator wall 838.

In some example embodiments, power connection box 110 may include wire openings 842 and 844 that may be used to route additional electrical cables between the power connection box 110 and other remote power units. For example, an electrical cable that may be used in AC power connection may be routed through the wire opening 842 and a wire opening 858 of the wiring compartment 814. As another example, an electrical cable that may be used in DC power connection may be routed through the wire opening 844 and a wire opening 860 of the wiring compartment 814.

In some example embodiments, the sidewall 834 may include slots 850, 852 and the sidewall 836 may include slots 854, 856. The slots 85-856 may be used to attach the power connection box 110 to the pole 104 of FIG. 1 using mounting bands such as the mounting band 116 shown in FIG. 1.

In some alternative embodiments, the power connection box 110 may have a different shape than shown without departing from the scope of this disclosure. In some alternative embodiments, some elements of the power connection box 110, such as openings, components, etc., may be at different locations than shown without departing from the scope of this disclosure. In some alternative embodiments, the AC compartment 802 and the DC compartment 804 may be switched without departing from the scope of this disclosure. In some alternative embodiments, the AC wiring section 862 and the DC wiring section 816 may be switched without departing from the scope of this disclosure. In some alternative embodiments, some elements of the power connection box 110 may be omitted without departing from the scope of this disclosure. For example, the AC wiring section 862 and the DC wiring section 816 may be omitted without departing from the scope of this disclosure.

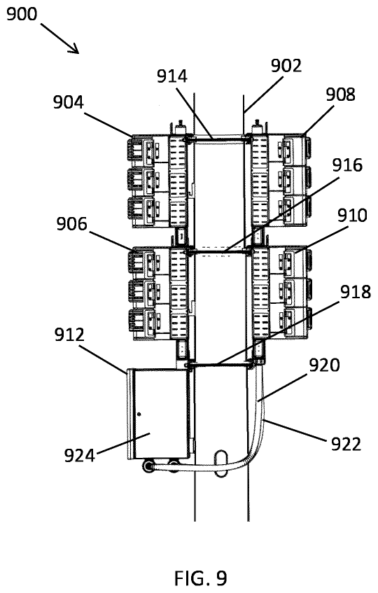

FIG. 9 illustrates a remote power system 900 of an outdoor lighting system according to another example embodiment. In some example embodiments, the remote power system 900 includes remote power unit assemblies 904, 906, 908, 910 and a power connection box 912 that are attached to a pole 902. For example, the remote power unit assemblies 904 and 908 may be attached to the pole 902 using mounting structures such as a mounting fastener 914, and the remote power unit assemblies 906 and 910 may be attached to the pole 902 using structures such as a mounting fastener 916 as can be readily understood by those of ordinary skill in the art. The power connection box 912 may be attached to the pole 902 using structures such as the mounting fastener 918 as can be readily understood by those of ordinary skill in the art.

In some example embodiments, the remote power system 900 may provide DC power to lightheads (e.g., LED lightheads) that are at a top end portion of the pole 902 in the manner described with respect to the remote power system 102 of FIG. 2. For example, the remote power system 900 may provide DC power to a lighthead assembly such as the lighthead assembly 120 shown in FIG. 1.

In some example embodiments, electrical cables between the remote power unit assemblies 904, 906 and the power connection box 912 may be routed generally in the manner described with respect to the remote power system 102 of FIG. 2. Because the remote power unit assemblies 908, 910 are on opposite side of the pole 902 from the power connection box 912, electrical cable between the remote power unit assemblies 908, 910 and the power connection box 912 may be at least partially routed through flexible conduits 920 and 922 as can be readily understood by those of ordinary skill in the art. In general, electrical cables that are used for AC power connection between each one of the remote power unit assemblies 904-910 and power connection box 912 may be routed separated from electrical cables that are used for DC power connection between the respective one of the remote power unit assemblies 904-910 and power connection box 912.

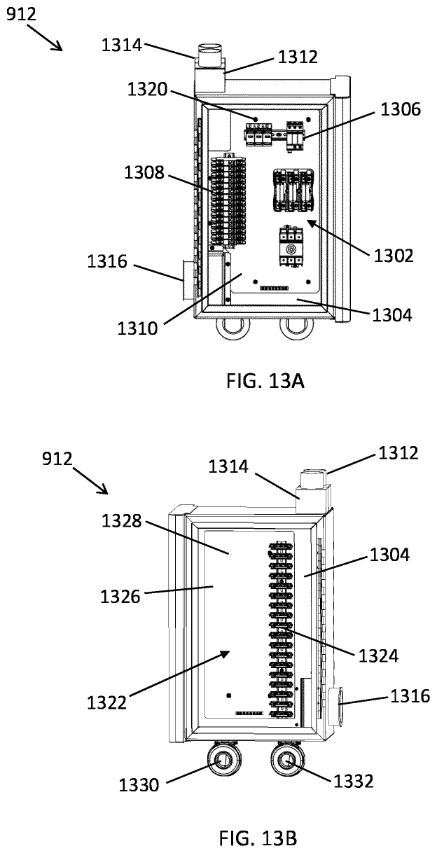

In some example embodiments, the power connection box 912 may include separate compartments for AC and DC components and connections as described below with respect to FIGS. 13A and 13B. For example, electrical connections used for AC power connection may be routed to one of the compartments of the power connection box 912, and electrical connections used for DC power connection may be routed to another compartment of the power connection box 912. One of the compartments of the power connection box 912 may be accessed by opening a door 924 of the power connection box 912, and the other compartment may be access by opening another door that is on the opposite side of the power connection box 912 from the door 924.

Because the remote power system 900 can provide DC power to a lighthead assembly while remotely located from the lighthead assembly, lightheads of the lighthead assembly 120 do not need to include local power supplies. By eliminating the need for lightheads to incorporate a driver, the remote power system 900 enables replacement of non-LED lightheads with LED lightheads.

In some alternative embodiments, the remote power system 900 may include more or fewer than four remote power unit assemblies shown in FIG. 9 without departing from the scope of this disclosure. In some alternative embodiments, one or more of the power unit assemblies 904-910 and the power connection box 912 may be attached to the pole 902 at different locations than shown without departing from the scope of this disclosure.

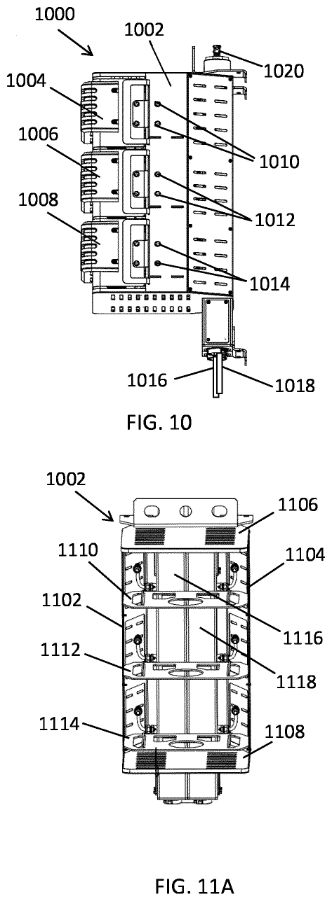

FIG. 10 illustrates a remote power unit assembly 1000 for use in the remote power system 900 of FIG. 9 according to an example embodiment. The remote power unit assembly 1000 corresponds to each one of the remote power unit assemblies 904-910 of the remote power system 900 of FIG. 9. Referring to FIGS. 9 and 10, in some example embodiments, the remote power unit assembly 1000 may include a mounting rack 1002 and remote power units 1004, 1006, 1008 attached to the mounting rack 1002. For example, the remote power unit 1004 may be attached to the mounting rack 1002 using at least fasteners 1010 (e.g., screws). The remote power unit 1006 may be attached to the mounting rack 1002 using at least fasteners 1012 (e.g., screws). The remote power unit 1008 may be attached to the mounting rack 1002 using at least fasteners 1014 (e.g., screws).

In some example embodiments, each one of the remote power units 1004, 1006, 1008 may receive AC power and may generate DC power from the AC power. For example, each one of the remote power units 1004, 1006, 1008 may include one or more drivers (e.g., LED drivers) that generate DC power compatible with LED lightheads. The remote power units 1004, 1006, 1008 may each be connected to the power connection box 912 that receives AC power over one or more electrical cables that are routed through the pole 902. The remote power units 1004, 1006, 1008 may be electrically coupled to the power connection box 912 and may receive AC power over an electrical cable 1016.

In some example embodiments, the remote power units 1004, 1006, 1008 may be electrically connected to the power connection box 912 via an electrical cable 1018 to provide DC power to lightheads at a top end portion of the pole 902 through the power connection box 912. To illustrate, DC power from the remote power units 1004, 1006, 1008 may be provided to lightheads over one or more electrical cables that are routed from the power connection box 912 through the inside of the pole 902.

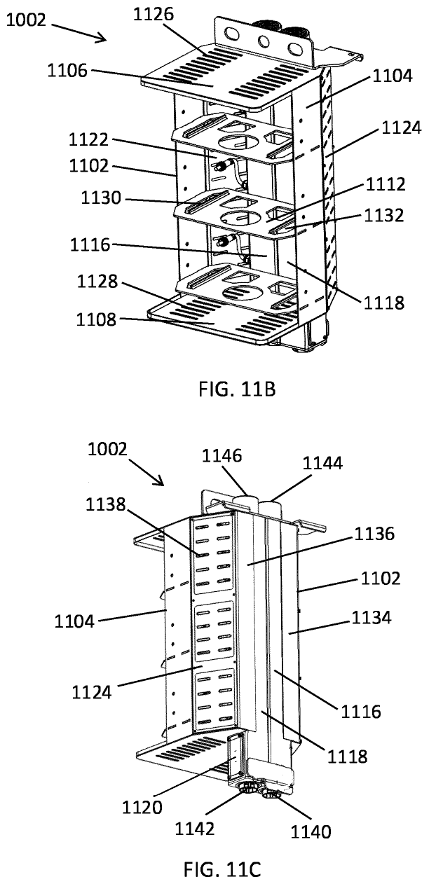

In some example embodiments, the electrical cables 1016, 1018 may be routed through respective wiring conduits (e.g., wiring conduits 1116, 1118 shown in FIGS. 11A-11C) of the mounting rack 1002 and may each be terminated at a respective connector (not shown) at a bottom end of the remote power unit assembly 1000. One or more wires of each of the electrical cables 1016, 1018 may also be terminated at one or more connectors 1020 at a top end of the remote power unit assembly 1000. One or more wires of each of the electrical cables 1016, 1018 may also be terminated inside wiring conduits (e.g., wiring conduits 1116, 1118 shown in FIGS. 11A-11C) of the mounting rack 1002 and electrically connected to a respective one of the remote power units 1004, 1006, 1008.

In some alternative embodiments, the remote power unit assembly 1000 may include more or fewer than three remote power units without departing from the scope of this disclosure. In some alternative embodiments, the electrical cables 1016, 1018 may be terminated inside the mounting rack 1002 at a bottom end of the remote power unit assembly 1000 without departing from the scope of this disclosure. In some alternative embodiments, the remote power units 1004, 1006, 1008 may be attached to the mounting rack 1002 using means other than the fasteners 1010, 1012, 1014 without departing from the scope of this disclosure.

FIGS. 11A-11C illustrate different views of the mounting rack 1002 of the remote power unit assembly 1000 of FIG. 10 used for attaching the remote power unit assembly of FIG. 10 to the pole 902 of FIG. 9 according to an example embodiment. Referring to FIGS. 11A-11C, in some example embodiments, the mounting rack 1002 may include side frames 1102, 1104, a top cover 1106, and a bottom cover 1108. The mounting rack 1002 may also include driver shelves 110, 112, 114 that are securing attached to the side frames 1102, 1104. For example, the driver shelves 110, 112, 114 may have tabs that are inserted in respective slots of the side frames 1102, 1104. Alternatively or in addition, the driver shelves 110, 112, 114 may be attached to the side frames 1102, 1104 using fasteners, welding, brackets, and/or other means as can be readily understood by those of ordinary skill in the art. The top cover 1106 and the bottom cover 1108 may also be attached to the side frames 1102, 1104 using fasteners, welding, brackets, and/or other means as can be readily understood by those of ordinary skill in the art.

In some example embodiments, the mounting rack 1002 may include wiring conduits 1116, 1118. For example, the wiring conduits 1116, 1118 may be separate structures or parts of an integral unit and may be attached to the side frames 1102, 1104. For example, the wiring conduits 1116, 1118 may be attached to the side frames 1102, 1104 using fasteners, welding, brackets, and/or other means as can be readily understood by those of ordinary skill in the art.

In some example embodiments, each one of the driver shelves 1110, 1112, 1114 is designed to hold a remote power unit. To illustrate, the remote power unit 1004 is positioned on the driver shelf 1110, the remote power unit 1006 is positioned on the driver shelf 1112, and the remote power unit 1008 is positioned on the driver shelf 1114. The driver shelves 1110, 1112, 1114 may each include guides, such as a guide 1130 of the driver shelf 1112, to facilitate the placement of the remote power units 1004, 1006, 1008 on a respective one of the driver shelves 1110, 1112, 1114. The driver shelves 1110, 1112, 1114 may each include multiple openings, such as an opening 1132 of the driver shelf 1112, for example, to reduce the overall weight of the mounting rack 1002.

In some example embodiments, the top cover 1106 may include vents 1126 for dissipating heat generated by the remote power units 1004, 1006, 1008. The bottom cover 1108 may also include vents 1128 for dissipating heat generated by the remote power units 1004, 1006, 1008.

In some example embodiments, a removable panel 1122 may be attached to the side frame 1102 using, for example, one or more fasteners. A removable panel 1124 may be attached to the side frame 1104 using, for example, one or more fasteners such as a fastener (e.g., a screw). The removable panels 1122, 1124 may include vents for dissipating heat generated by the remote power units 1004, 1006, 1008. For example, the removable panel 1124 may include vents such as the vent 1138.

In some example embodiments, the side frame 1102 may include a flange 1134 that may help retain the wiring conduit 1116 attached to the side frame 1102. The side frame 1104 may include a flange 1136 that may help retain the wiring conduit 1118 attached to the side frame 1104. For example, the flange 1134 may be welded to the wiring conduit 1116, and the flange 1136 may be welded to the wiring conduit 1118. The wiring conduit 1116 may have openings 1144 and 1140 for routing electrical cables in, out, and/or through the wiring conduit 1116. For example, the electrical cable 1016 may be used for AC power connection, and the wiring conduit 1116 may be used to route the electrical cable 1016 (shown in FIG. 10) therethrough. The wiring conduit 1118 may have openings 1146 and 1142 for routing electrical cables in, out, and/or through the wiring conduit 1118. For example, the electrical cable 1018 may be used for DC power connection, and the wiring conduit 1118 may be used to route the electrical cable 1018 (shown in FIG. 10) therethrough. By providing separate pathways for the electrical cables 1016, 1018, the wiring conduits 1116, 1118 may enable the separate routing of AC power electrical cables from DC power electrical cables.

In some example embodiments, the wiring conduit 1116 may include a removable door 1120 that provides access to a cavity of the wiring conduit 1116 as more clearly shown in FIG. 11C. For example, wire connections and adjustments in a cavity of the wiring conduit 1116 may be made by removing the removable door 1120 and accessing the cavity. To illustrate, the removable door 1120 may be removed, for example, by removing one or more fasteners that attach the removable door 1120 to the wiring conduit 1116. In some example embodiments, the wiring conduit 1118 may also include a removable door similar to the removable door 1120.

In some example embodiments, the mounting rack 1002 may be made from sheet metal, such as aluminum and/or steel sheet metal. The mounting rack 1002 may be made using methods such as cutting, bending, welding, fastening, etc.

In some alternative embodiments, the mounting rack 1002 may have more or fewer than three driver shelves without departing from the scope of this disclosure. In some alternative embodiments, one or more components of the mounting rack 1002 may have a different shape than shown without departing from the scope of this disclosure. For example, the wiring conduits 1116, 1118 may be a round or rectangular cross section for the entire lengths. In some alternative embodiments, the driver shelves 1110, 1112, 1114 may have a different shape and/or more or fewer openings (e.g., the opening 1132 of the driver shelf 1112) than shown without departing from the scope of this disclosure. In some alternative embodiments, one or more guides (e.g., the guide 1130 of the driver shelf 1112) of the driver shelves 1110, 1112, 1114 may be omitted without departing from the scope of this disclosure.

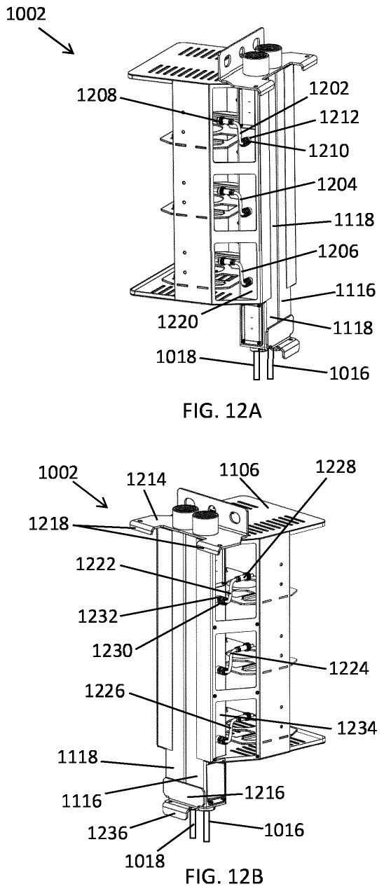

FIGS. 12A and 12B illustrate the mounting rack 1002 of FIGS. 11A-4C with the removable panels 1122, 1124 removed for clarity of illustration according to an example embodiment. In some example embodiments, electrical cables 1202, 1204, 1206 are coupled to respective connectors attached to a sidewall 1220 of the wiring conduit 1118 as more clearly shown in FIG. 12A. For example, the electrical cable 1202 may include connectors 1208 and 1210 at opposite ends of the electrical cable 1202. The connector 1208 is designed to be connected to the remote power unit 1004 shown in FIG. 10, and the connector 1210 may be connected to a connector 1212 that is attached to the sidewall 1220. The electrical cable 1204 may be electrically connected to the remote power unit 1006, and the electrical cable 1206 may be electrically connected to the remote power unit 1008 shown in FIG. 10.

In some example embodiments, the electrical cable 1202 may be electrically connected to one or more wires of the electrical cable 1018 via the connectors 1210, 1212, establishing an electrical connection between the remote power unit 1004 (when the connector 1208 is attached to the remote power unit 1004) and the electrical cable 1018. For example, the electrical cable 1202 may be used to provide DC power from the remote power unit 1004. The electrical cables 1204 and 1206 may also be electrically connected to respective one or more wires of the electrical cable 1018 and may be used to provide DC power from the respective one of the remote power units 1006, 1008 shown in FIG. 10.

In some example embodiments, electrical cables 1222, 1224, 1226 are coupled to respective connectors attached to a sidewall 1234 of the wiring conduit 1116 as more clearly shown in FIG. 12B. For example, the electrical cable 1222 may include connectors 1228 and 1230 at opposite ends of the electrical cable 1222. The connector 1228 is designed to be connected to the remote power unit 1004 shown in FIG. 10, and the connector 1230 may be connected to a connector 1232 that is attached to the sidewall 1234. The electrical cable 1224 may be electrically connected to the remote power unit 1006, and the electrical cable 1226 may be electrically connected to the remote power unit 1008 shown in FIG. 10.

In some example embodiments, the electrical cable 1222 may be electrically connected to one or more wires of the electrical cable 1016 via the connectors 1230, 1232, establishing an electrical connection between the remote power unit 1004 (when the connector 1228 is attached to the remote power unit 1004) and the electrical cable 1016. For example, the electrical cable 1222 may be used to provide AC power to the remote power unit 1004. The electrical cables 1224 and 1226 may also be electrically connected to respective one or more wires of the electrical cable 1016 and may be used to provide AC power to the respective one of the remote power units 1006, 1008 shown in FIG. 10.

In some example embodiments, the mounting rack 1002 may include brackets 1214 and 1216 as more clearly shown in FIG. 12B. For example, the bracket 1214 may be attached to the top cover 1106 by fasteners and/or other means such as welding. The bracket 1214 may include tabs 1218 that may be used to retain a mounting rod that can be used in mounting the mounting rack 1004 attached to the pole 902 shown in FIG. 9. The bracket 1216 may be attached (e.g., welded) to the wiring conduits 1116, 1118 and may be used in mounting the mounting rack 1002 to the pole 902. For example, the bracket 1216 may include a tab 1236 that may be used to retain a mounting rod that can be used in mounting the mounting rack 1004 to the pole 902.

By providing separate wiring conduits for AC and DC power connections, the mounting rack 1002 improves the separation of AC and DC power, which can, for example, reduce signal interference. By using the electrical cables 1202-1206, 1222-1226 that are connected to either the electrical cable 1016 or 1018 using connectors that are wired inside the wiring conduits 1116, 1118, the remote power units 1004, 1006, 1008 may be conveniently connected to the electrical cables 1016, 1018 to establish electrical connections with the power connection box 912 shown in FIG. 9.

In some alternative embodiments, one or more connectors of the electrical cables 1202-1206, 1222-1226 may be coupled at different sides of the wiring conduits 1116, 1118 than shown without departing from the scope of this disclosure. In some alternative embodiments, one or more connectors of the electrical cables 1202-1206, 1222-1226 may be omitted without departing from the scope of this disclosure.

FIGS. 13A and 13B illustrate different views of the power connection box 912 of the remote power system 900 of FIG. 9 according to an example embodiment. In FIGS. 13A and 13B, the power connection box 912 is shown without doors, such as the door 924 shown in FIG. 9, for clarity of illustration. The power connection box 912 may be made from sheet metal, such as aluminum and/or steel sheet metal, using methods such as cutting, bending, welding, etc.

In some example embodiments, the power connection box 912 may include an AC compartment 1302 and a DC compartment 1322 that are separated from each other by a backwall 1304. The AC compartment 1302 may contain components such as a surge protector 1306, circuit breakers 1308, etc. that are attached to a back plate 1310. The back plate 1310 may be attached to the backwall 1304 by one or more fasteners, such as the fastener 1320.

In some example embodiments, the DC compartment 802 may include components, such as wire connectors 1324, etc., that are attached to a back plate 1326. The back plate 1326 may be attached to the backwall 1304 using one or more fasteners, such as the fastener 1328. The power connection box 110 may be made from sheet metal, such as aluminum and/or steel sheet metal, using methods such as cutting, bending, welding, etc.

In some example embodiments, the power connection box 912 may include wire conduits 1312, 1314 for routing sections of electrical cables that are routed between the power connection box 912 and, for example, the remote power unit assemblies 904, 906 shown in FIG. 9. For example, the wire conduit 1312 may be used to route electrical cables that are used for AC power connection, and the wire conduit 1314 may be used to route electrical cables that are used for DC power connection. To illustrate, the electrical cable 1016 or another electrical cable coupled to the electrical cable 1016 may be routed through the wire conduit 1312 and may be connected to one or more components in the AC compartment 1302 of the power connection box 912. The electrical cable 1018 or another electrical cable coupled to the electrical cable 1018 may be routed through the wire conduit 1314 and may be connected to one or more components in the DC compartment 1322 of the power connection box 912. In general, the wire conduits 1312 and 1314 are separated from each other and provide separated routed of AC power connection electrical cables from DC power connection electrical cables.

In some example embodiments, the power connection box 912 may also include wire conduits 1330, 1332 for routing sections of electrical cables that are routed between the power connection box 912 and, for example, the remote power unit assemblies 908, 910 of FIG. 9 through flexible conduits 920, 922 shown in FIG. 9. To illustrate, the flexible conduits 920 and 922 may be connected to the wire conduits 1330 and 1332, respectively. For example, electrical cables that are used for AC power connection may be routed through the wire conduit 1330, and electrical cables that are used for DC power connection may be routed through the wire conduit 1332, or vice versa. In general, the wire conduits 1330 and 1332 are separated from each other and provide separated routed of AC power connection electrical cables from DC power connection electrical cables.

In some example embodiments, the power connection box 912 includes a wire opening 1316 that may be used for electrical wire routing between the power connection box 912 and the inside of the pole 902 shown in FIG. 9. For example, the wire opening 1316 may be aligned with an opening in the pole 902 as can be readily understood by those of ordinary skill in the art.

By providing separate routing and compartments for AC power connections and DC power connections, the power connection box 912 can simplify reduce interference between AC power and DC power. The power connection box 912 can also simplify maintenance and repair by separating AC and DC components.

In some alternative embodiments, the power connection box 912 may have a different shape than shown without departing from the scope of this disclosure. In some alternative embodiments, some elements of the power connection box 912, such as openings, components, etc., may be at different locations than shown without departing from the scope of this disclosure. In some alternative embodiments, the AC compartment 1302 and the DC compartment 1322 may be switched without departing from the scope of this disclosure. In some alternative embodiments, some elements of the power connection box 912 may be omitted without departing from the scope of this disclosure. For example, the wire conduits 1330, 1332 may be omitted without departing from the scope of this disclosure. In some alternative embodiments, the power connection box 912 may include another pair of wire conduits that may be used for separate routing of AC and DC electrical cables without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

1. A mounting rack for attachment of a remote power unit to a structure, the mounting rack comprising:
a first side frame;
a second side frame;
a separator plate, wherein the first side frame and the separator plate provide an alternating current (AC) wiring pathway therebetween for routing a first electrical cable, wherein the second side frame and the separator plate provide a direct current (DC) wiring pathway therebetween for routing a second electrical cable, and wherein the AC wiring pathway and the DC wiring pathway are separated by the separator plate;
a bottom plate attached to the first side frame and the second side frame, the bottom plate having a first wire opening aligned with the AC wiring pathway and a second wire opening aligned with the DC wiring pathway; and
a top plate attached to the first side frame and the second side frame, the top plate having a third wire opening aligned with the AC wiring pathway and a fourth wire opening aligned with the DC wiring pathway.

2. The mounting rack of claim 1, further comprising a front plate having a third wire opening aligned with the AC wiring pathway and a fourth wire opening aligned with the DC wiring pathway.

3. The mounting rack of claim 1, wherein the first side frame and the second side frame each comprise a fastener hole for attaching the remote power unit to the mounting rack using one or more fasteners.

4. The mounting rack of claim 3, further comprising a hollow tube aligned with the first fastener hole and the second fastener hole, wherein the hollow tube extends through a hole in the separator plate.

5. The mounting rack of claim 3, wherein the first side frame and the second side frame each further comprise a second fastener hole for attaching the remote power unit to the mounting rack using second one or more fasteners.

6. The mounting rack of claim 1, wherein the first side frame and the second side frame each comprise one or more slots for extending one or more mounting bands therethrough for attaching the mounting rack to the structure.

7. The mounting rack of claim 1, further comprising a support rung extending between and attached to the first side frame and the second side frame.

8. A remote power unit assembly, comprising:
a remote power unit;
a bracket attached to the remote power unit; and
a mounting rack, comprising:
a first side frame;
a second side frame; and
a separator plate, wherein the first side frame and the separator plate provide an alternating current (AC) wiring pathway therebetween for routing a first electrical cable, wherein the second side frame and the separator plate provide a direct current (DC) wiring pathway therebetween for routing a second electrical cable, wherein the AC wiring pathway and the DC wiring pathway are separated by the separator plate, and wherein the bracket is attached to the first side frame and the second side frame;
wherein the first side frame and the second side frame each comprise a fastener hole, and wherein the bracket is attached to the first side frame and the second side frame using one or more fasteners extending through the fastener hole of each of the first side frame and the second side frame; and
wherein the mounting rack further comprises a hollow tube aligned with the fastener hole of each of the first side frame and the second side frame and wherein the hollow tube extends through a hole in the separator plate.

9. The remote power unit assembly of claim 8, wherein the mounting rack further comprises a bottom plate attached to the first side frame and the second side frame, the bottom plate having a first wire opening aligned with the AC wiring pathway and a second wire opening aligned with the DC wiring pathway.

10. The remote power unit assembly of claim 9, wherein the mounting rack further comprises a front plate having a third wire opening aligned with the AC wiring pathway and a fourth wire opening aligned with the DC wiring pathway such that the first electrical cable is routed from the remote power unit through the third wire opening, a portion of the AC wiring pathway, and the first wire opening and such that the second electrical cable is routed from the remote power unit through the fourth wire opening, a portion of the DC wiring pathway, and the second wire opening.

11. The remote power unit assembly of claim 8, wherein the first side frame and the second side frame each comprise one or more slots for extending one or more mounting bands therethrough for attaching the mounting rack to a structure.
